(19) United States
(12) Patent Application Publication
(10) Pub. No.: US 2006/0251384 A1
(43) Pub. Date: Nov. 9, 2006

(54) Automatic video editing for real-time multi-point video conferencing

(75) Inventors: David Vronay, Beijing (CN); Shuo Wang, Beijing (CN); Dingmei Zhang, Beijing (CN); Weiwei Zhang, Beijing (CN)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 11/182,565

(22) Filed: Jul. 15, 2005

Related U.S. Application Data
(62) Division of application No. 11/125,384, filed on May 9, 2005.

(51) Int. Cl. H04N 5/93

(52) U.S. Cl. 386/52

(57) ABSTRACT

An “automated video editor” (AVE) automatically processes one or more input videos to create an edited video stream with little or no user interaction. The AVE produces cinematic effects such as cross-cuts, zooms, pans, insets, 3-D effects, etc., by applying a combination of cinematic rules, object recognition techniques, and digital editing of the input video. Consequently, the AVE is capable of using a simple video taken with a fixed camera to automatically simulate cinematic editing effects that would normally require multiple cameras and/or professional editing. The AVE first defines a list of scenes in the video and generates a rank-ordered list of candidate shots for each scene. Each frame of each scene is then analyzed or “parsed” using object detection techniques (“detectors”) for isolating unique objects (faces, moving/stationary objects, etc.) in the scene. Shots are then automatically selected for each scene and used to construct the edited video stream.

### CROSS REFERENCE TO RELATED APPLICATIONS

This application is a Divisional Application of U.S. patent application Ser. No. 11/125,384, filed on May 9, 2005, by Vronay, et al., and entitled “SYSTEM AND METHOD FOR AUTOMATIC VIDEO EDITING USING OBJECT RECOGNITION,” and claims the benefit of that prior application under Title 35, U.S. Code, Section 120.

### BACKGROUND

1. Technical Field

The invention is related to automated video editing, and in particular, to a system and method for using a set of cinematic rules in combination with one or more object detection or recognition techniques and automatic digital video editing to automatically analyze and process one or more input video streams to produce an edited output video stream.

2. Related Art

Recorded video streams, such as speeches, lectures, birthday parties, video conferences, or any other collection of shots and scenes, etc. are frequently recorded or captured using video recording equipment so that resulting video can be played back or viewed at some later time, or broadcast in real-time to a remote audience.

The simplest method for creating such video recordings is to have one or more cameramen operating one or more cameras to record the various scenes, shots, etc. of the video recording. Following the conclusion of the video recording, the recordings from the various cameras are then typically manually edited and combined to provide a final composite video which may then be made available for viewing. Alternately, the editing can also be done on the fly using a film crew consisting of one or more cameramen and a director, whose role is to choose the right camera and shot at any particular time.

Unfortunately, the use of human camera operators and manual editing of multiple recordings to create a composite video of various scenes of the video recording is typically a fairly expensive and/or time consuming undertaking. Consequently, several conventional schemes have attempted to automate both the recording and editing of video recordings, such as presentations or lectures.

For example, one conventional scheme for providing automatic camera management and video creation generally works by manually positioning several hardware components, including cameras and microphones, in predefined positions within a lecture room. Views of the speaker or speakers and any PowerPoint™ type slides are then automatically tracked during the lecture. The various cameras will then automatically switch between the different views as the lecture progresses. Unfortunately, this system is based entirely in hardware, and tends to be both expensive to install and difficult to move to different locations once installed.

Another conventional scheme operates by automatically recording presentations with a small number of unmoving (and unmanned) cameras which are positioned prior to the start of the presentation. After the lecture is recorded, it is simply edited offline to create a composite video which includes any desired components of the presentation. One advantage to this scheme is that it provides a fairly portable system and can operate to successfully capture the entire presentation with a small number of cameras and microphones at relatively little cost. Unfortunately, the offline processing required to create the final video tends to very time consuming, and thus, more expensive. Further, because the final composite video is created offline after the presentation, this scheme is not typically useful for live broadcasts of the composite video of the presentation.

Another conventional scheme addresses some of the aforementioned problems by automating camera management in lecture settings. In particular, this scheme provides a set of videography rules to determine automated camera positioning, camera movement, and switching or transition between cameras. The videography rules used by this scheme depend on the type of presentation room and the number of audio-visual camera units used to capture the presentation. Once the equipment and videography rules are set up, this scheme is capable of operating to capture the presentation, and then to record an automatically edited version of the presentation. Real-time broadcasting of the captured presentation is also then available, if desired.

Unfortunately, the aforementioned scheme requires that the videography rules be custom tailored to each specific lecture room. Further, this scheme also requires the use of a number of analog video cameras, microphones and an analog audio-video mixer. This makes porting the system to other lecture rooms difficult and expensive, as it requires that the videography rules be rewritten and recompiled any time that the system is moved to a room having either a different size or a different number or type of cameras.

### SUMMARY

An “automated video editor” (AVE), as described herein, operates to solve many of the problems with existing automated video editing schemes by providing a system and method which automatically produces an edited output video stream from one or more raw or previously edited video streams with little or no user interaction. In general, the AVE automatically produces cinematic effects, such as cross-cuts, zooms, pans, insets, 3-D effects, etc., in the edited output video stream by applying a combination of cinematic rules, conventional object detection or recognition techniques, and digital editing to the input video streams. Consequently, the AVE is capable of using a simple video taken with a fixed camera to automatically simulate cinematic editing effects that would normally require multiple cameras and/or professional editing.

In various embodiments, the AVE is capable of operating in either a fully automatic mode, or in a semi-automatic user assisted mode. In the semi-automatic user assisted mode, the user is provided with the opportunity to specify particular scenes, shots, or objects of interest. Once the user has specified the information of interest, the AVE then proceeds to process the input video streams to automatically generate an automatically edited output video stream, as with the fully automatic mode noted above.

In general, the AVE begins operation by receiving one or more input video streams. Each of theses streams is then analyzed using any conventional scene detection technique to partition each video stream into one or more scenes. As is well known to those skilled in the art, there are many ways of detecting scenes in a video stream.

For example, one common method is to use conventional speaker identification techniques to identify a person that is currently talking with conventional point-to-point or multipoint video teleconferencing applications, then, as soon as another person begins talking, that transition corresponds to a “scene change.” A related conventional technique for speaker detection is frequently performed in real-time using microphone arrays for detecting the direction of received speech, and then using that direction to point a camera towards that speech source. Other conventional scene detection techniques typically look for changes in the video content, with any change from frame to frame that exceeds a certain threshold being identified as representing a scene transition. Note that such techniques are well known to those skilled in the art, and will not be described in detail herein.

Once the input video streams have been partitioned into scenes, each scene is then separately analyzed to identify potential shots in each scene to define a “candidate list” of shots. This candidate list generally represents a rank-ordered list of shots that would be appropriate for a particular scene.

In general, shots represent a number of sequential image frames, or some sub-section of a set of sequential image frames, comprising an uninterrupted segment of a video sequence. Basically, the shot represents some subset of a scene, up to, and including, the entire scene, or some collection of portions of several source videos that are to be arranged in some predetermined fashion. From any given scene, there are typically a number of possible shots.

For example, a shot might consist of a digital pan of all or part of a scene, where a fixed size rectangle tracks across the input video stream (with the contents of the rectangle either being scaled to the desired video output size, and/or mapped to an inset in the output video). Another shot might consist of a digital zoom, where a rectangle that changes size over time tracks across a scene of the input video stream, or remains in one location while changing size (with the contents of the rectangle again being scaled to the desired video output size, and/or mapped to an inset in the output video).

With respect to shots involving insets, this simply represents an instance where one image (such as a particular detected face or object) is shown inset into another image or background. Note that the use of insets is well known to those skilled in the art, and will not be described in detail herein. Still other possible shots involve 3D effects where an image (such as a particular detected face or object) is shown mapped onto the surface of a 3D object. Such 3D mapping techniques are well known to those skilled in the art, and will not be described in detail herein.

It should be noted that the candidate list of possible shots for each scene generally depends on what type of detectors (face recognition, object recognition, object tracking, etc.) are available. However, in the case of user interaction, particular shots can also be manually specified by the user in addition to any shots that may be automatically added to the candidate list.

Once the candidate list of shots has been defined for each scene, the AVE then analyzes the corresponding input video streams to identify particular elements in each scene. In other words, each scene is “parsed” by using the various detectors to see what information can be gleaned from the current scene. The exact type of parsing depends upon the application, and can be affected by many factors, such as which shots the AVE is interested in, how accurate the detectors are, and even how fast the various detectors can work. For example, if the AVE is working with live video (such as in a video teleconferencing application, for example), the AVE must be able to complete all parsing in less than 1/30th of a second (or whatever the current video frame rate might be).

It must be noted that the shot selection described above is independent from the video parsing. Consequently, assuming that the parsing detects objects A, B, and C in one or more video streams, the AVE could request a shot such as “cut from object A to object B to object C” without knowing (or caring) if A, B, and C are in different locations in a single video stream or each have their own video stream.

Next, a best shot is selected for each scene from the list of candidate shots based on the parsing analysis and a set of cinematic rules. In general, the cinematic rules represent types of shots that should occur either more or less frequently, or should be avoided, if possible. For example, conventional video editing techniques typically consider a zoom in immediately followed by a zoom out to be bad style. Consequently, a cinematic rule can be implemented so that such shots will be avoided. Other examples of cinematic rules include avoiding too many of the same shot in a row, avoiding a shot that would be too extreme with the current video data (such as a pan that would be too fast or a zoom that would be too extreme (e.g., too close to the target object). Note that these cinematic rules are just a few examples of rules that can be defined or selected for use by the AVE. In general, any desired type of cinematic rule desired can be defined. The AVE then processes those rules in determining the best shot for each scene.

Finally, given the selection of the best shot for each scene, the edited output video stream is then automatically constructed from the input video stream by constructing and concatenating one or more shots from the input video streams.

In view of the above summary, it is clear that the “automated video editor” (AVE) described herein provides a unique system and method for automatically processing one or more input video streams to provide an edited output video stream. In addition to the just described benefits, other advantages of the AVE will become apparent from the detailed description which follows hereinafter when taken in conjunction with the accompanying drawing figures.

### DESCRIPTION OF THE DRAWINGS

The specific features, aspects, and advantages of the present invention will become better understood with regard to the following description, appended claims, and accompanying drawings where:

FIG. 1 is a general system diagram depicting a general-purpose computing device constituting an exemplary system implementing a automated video editor (AVE), as described herein.

FIG. 2 provides an example of a typical fixed-camera setup for recording a “home movie” version of a scene.

FIG. 3 provides a schematic example of a several video frames that could be captured by the camera setup of FIG. 2.

FIG. 4 provides an example of a typical multi-camera setup for recording a “professional movie” version of a scene.

FIG. 5 provides a schematic example of a several video frames that could be captured by the camera setup of FIG. 4 following professional editing.

FIG. 6 illustrates an exemplary architectural system diagram showing exemplary program modules for implementing an AVE, as described herein.

FIG. 7 provides an example of a bounding quadrangle represented by points {a, b, c, d} encompassing a detected face in an image.

FIG. 8 provides an example of the bounded face of FIG. 7 mapped to a quadrangle {a′, b′, c′, d′} in an output video frame.

FIG. 9 illustrates an image frame including 16 faces.

FIG. 10 illustrates each of the 16 faces detected of FIG. 9 shown bounded by bounding quadrangles following detection by a face detector.

FIG. 11 illustrates several examples of shots that can be derived from one or more input source videos.

FIG. 12 illustrates an exemplary setup for a multipoint video conference system.

FIG. 13 illustrates exemplary raw source video streams derived from the exemplary multipoint video conference system of FIG. 12.

FIG. 14 illustrates several examples of shots that can be derived from the raw source video streams illustrated in FIG. 13.

### DETAILED DESCRIPTION OF THE PREFERRED EMBODIMENTS

In the following description of the preferred embodiments of the present invention, reference is made to the accompanying drawings, which form a part hereof, and in which is shown by way of illustration specific embodiments in which the invention may be practiced. It is understood that other embodiments may be utilized and structural changes may be made without departing from the scope of the present invention.

1.0 Exemplary Operating Environment:

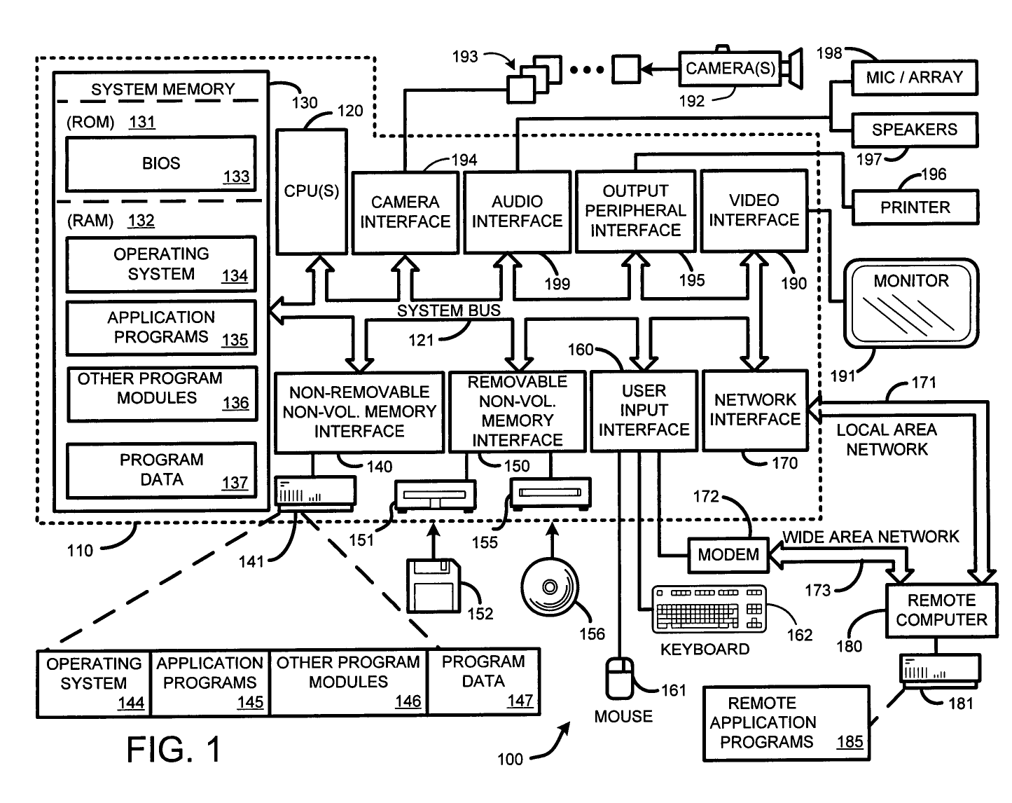

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer in combination with hardware modules, including components of a microphone array 198. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. With reference to FIG. 1, an exemplary system for implementing the invention includes a general-purpose computing device in the form of a computer 110.

Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules, or other data.

Computer storage media includes, but is not limited to, RAM, ROM, PROM, EPROM, EEPROM, flash memory, or other memory technology; CD-ROM, digital versatile disks (DVD), or other optical disk storage; magnetic cassettes, magnetic tape, magnetic disk storage, or other magnetic storage devices; or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball, or touch pad.

Other input devices (not shown) may include a joystick, game pad, satellite dish, scanner, radio receiver, and a television or broadcast video receiver, or the like. These and other input devices are often connected to the processing unit 120 through a wired or wireless user input interface 160 that is coupled to the system bus 121, but may be connected by other conventional interface and bus structures, such as, for example, a parallel port, a game port, a universal serial bus (USB), an IEEE 1394 interface, a Bluetooth™ wireless interface, an IEEE 802.11 wireless interface, etc. Further, the computer 110 may also include a speech or audio input device, such as a microphone or a microphone array 198, as well as a loudspeaker 197 or other sound output device connected via an audio interface 199, again including conventional wired or wireless interfaces, such as, for example, parallel, serial, USB, IEEE 1394, Bluetooth™, etc.

A monitor 191 or other type of display device is also connected to the system bus 121 via an interface, such as a video interface 190. In addition to the monitor 191, computers may also include other peripheral output devices such as a printer 196, which may be connected through an output peripheral interface 195.

Further, the computer 110 may also include, as an input device, a camera 192 (such as a digital/electronic still or video camera, or film/photographic scanner) capable of capturing a sequence of images 193. Further, while just one camera 192 is depicted, multiple cameras of various types may be included as input devices to the computer 110. The use of multiple cameras provides the capability to capture multiple views of an image simultaneously or sequentially, to capture three-dimensional or depth images, or to capture panoramic images of a scene. The images 193 from the one or more cameras 192 are input into the computer 110 via an appropriate camera interface 194 using conventional interfaces, including, for example, USB, IEEE 1394, Bluetooth™, etc. This interface is connected to the system bus 121, thereby allowing the images 193 to be routed to and stored in the RAM 132, or any of the other aforementioned data storage devices associated with the computer 110. However, it is noted that previously stored image data can be input into the computer 110 from any of the aforementioned computer-readable media as well, without directly requiring the use of a camera 192.

The computer 110 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The exemplary operating environment having now been discussed, the remaining part of this description will be devoted to a discussion of the program modules and processes embodying a “automated video editor” (AVE) which provides automated editing of one or more video streams to produce an edited output video stream.

2.0 Introduction:

The wide availability and easy operation of video cameras make video capture of various events a very frequent occurrence. However, while such videos are fairly simple to capture, the video produced is often fairly boring to watch unless some editing or post-processing is applied to the video. Clearly, much of the “language” or drama of cinema is accomplished through sophisticated camera work and editing.

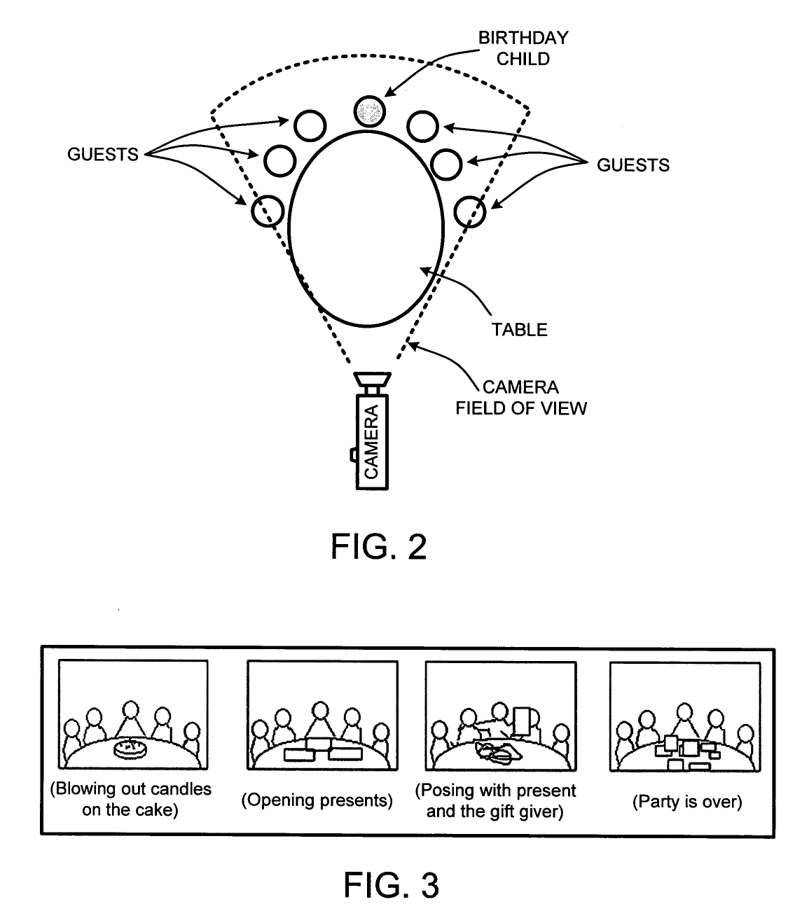

For example, in the case of a simple children's birthday party filmed by a typical parent, the parent will often put a video camera on a tripod and simply point it at the birthday child. The camera will typically be placed be far enough away to ensure a wide field of view, so that the majority of the scene, including the birthday child, presents, other guests, gifts, etc., are captured. A typical setup for recording such a scene is illustrated by the overhead view of the general video camera set-up shown in FIG. 2. Typically, the parent will turn on the camera and record the entire video sequence in a single take, resulting in a video recording which typically lacks drama and excitement, even though it captures the entire event. A schematic example of a several video frames that might be captured by the camera setup of FIG. 2 are illustrated in FIG. 3 (along with a brief description of what such frames might represent).

Clearly, it is possible for the film maker (the parent in this case) to make a more dramatic movie by moving the camera and/or using the zoom functionality. However, there are two drawbacks to this. First, the parent normally wants to be an active participant in the event, and if the parent must be a camera operator as well, they cannot easily enjoy the event. Second, because the event is generally unfolding before them in a loosely or non-scripted way, the parent does not have a good sense of what they should be filming. For example, if one child makes a particularly funny face, the parent may have the camera focused elsewhere, resulting in a potentially great shot or scene that is simply lost forever. Consequently, to make the best possible movie, the parent would need to know what is going to happen in advance, and then edit the video recording accordingly.

In the case of the “professional” version of the same birthday party, the professional videographer (or camera crew) would typically use one or more cameras to ensure adequate coverage of the scene from various angles and positions as the event (e.g., the birthday party) unfolds. Once the footage is captured, a professional editor would then choose which of the available shots best convey the action and emotion of the scene, with those shots then being combined to generate the final edited version of the video. Alternately, for a more scripted event, a single camera might be used, and each scene would be shot in any desired order, then combined and edited, as described above, to produce the final edited version of the video.

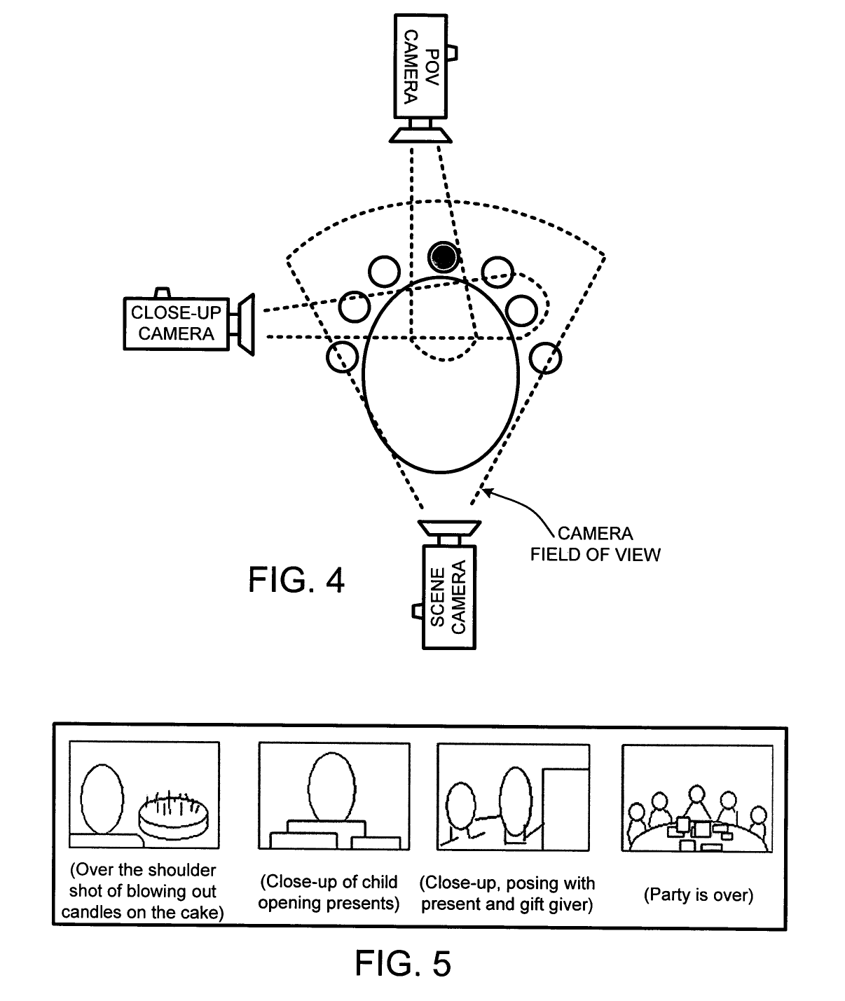

For example, a typical “professional” camera set-up for the birthday party described above might include three cameras, including a scene camera, a close-up camera, and a point of view camera (which shoots over the shoulder of the birthday child to capture the party from that child's perspective), as illustrated by FIG. 4. Once the footage is captured from this set of cameras, a professional editor would then choose which of the available shots best convey the action and emotion of each scene. A schematic example of a several video frames that might be captured by the camera setup of FIG. 4, following the professional editing, are illustrated in FIG. 5 (along with a brief description of what such frames might represent).

In general, the professionally edited video is typically a much better quality video to watch than the parent's “home movie” version of the same event. One of reasons that the professional version is a better product is that it considers several factors, including knowledge of significant moments in the recorded material, the corresponding cinematic expertise to know which form of editing is appropriate for representing those moments, and of course, the appropriate source material (e.g., the video recordings) that these shots require.

To address these issues, an “automated video editor” (AVE), as described herein, provides the capability to automatically generate an edited output version of the video stream, from one or more raw or previously edited input video streams, that approximates the “professional” version of a recorded event rather than the “home movie” version of that event with little or no user interaction. In general, the AVE automatically produces cinematic effects, such as cross-cuts, zooms, pans, insets, 3-D effects, etc., in the edited output video stream by applying a combination of predefined cinematic rules, conventional object detection or recognition techniques, and automatic digital editing of the input video streams. Consequently, the AVE is capable of using a simple video taken with a fixed camera to automatically simulate cinematic editing effects that would normally require multiple cameras and/or professional editing.

In various embodiments, the AVE is capable of operating in either a fully automatic mode, or in a semi-automatic user assisted mode. In the semi-automatic user assisted mode, the user is provided with the opportunity to specify particular scenes, shots, or objects of interest. Once the user has specified the information of interest, the AVE then proceeds to process the input video streams to automatically generate the edited output video stream, as with the fully automatic mode noted above.

2.1 System Overview:

As noted above, the “automated video editor” (AVE) described herein provides a system and method for producing an edited output video stream from one or more input video streams.

The AVE begins operation by receiving one or more input video streams. Each of theses streams is then analyzed using any conventional scene detection technique to partition each video stream into one or more scenes.

Once the input video streams have been partitioned into scenes, each scene is then separately analyzed to identify potential shots in each scene to define a “candidate list” of shots. This candidate list generally represents a rank-ordered list of shots that would be appropriate for a particular scene. It should be noted that the candidate list of possible shots for each scene generally depends on what type of detectors (face recognition, object recognition, object tracking, etc.) are being used by the AVE to identify candidate shots. However, in the case of user interaction, particular shots can also be manually specified by the user in addition to any shots that may be automatically added to the candidate list.

Once the candidate list of shots has been defined for each scene, the AVE then analyzes the corresponding input video streams to identify particular elements in each scene. In other words, each scene is “parsed” by using the various detectors (face recognition, object recognition, object tracking, etc.) to see what information can be gleaned from the current scene.

Next, a best shot is selected for each scene from the list of candidate shots based on the parsing analysis and application of a set of cinematic rules. In general, the cinematic rules represent types of shots that should occur either more or less frequently, or should be avoided, if possible. For example, conventional video editing techniques typically consider a zoom in immediately followed by a zoom out to be bad style. Consequently, a cinematic rule can be implemented so that such shots will be avoided. Other examples of cinematic rules include avoiding too many of the same shot in a row, avoiding a shot that would be too extreme with the current video data (such as a pan that would be too fast or a zoom that would be too extreme (e.g., too close to the target object). Note that these cinematic rules are just a few examples of rules that can be defined or selected form use by the AVE. In general, any desired type of cinematic rule desired can be defined. The AVE then processes those rules in determining the best shot for each scene.

Finally, given the selection of the best shot for each scene, the edited output video stream is then automatically constructed from the input video stream by constructing and concatenating one or more shots from the input video stream.

2.2 System Architectural Overview:

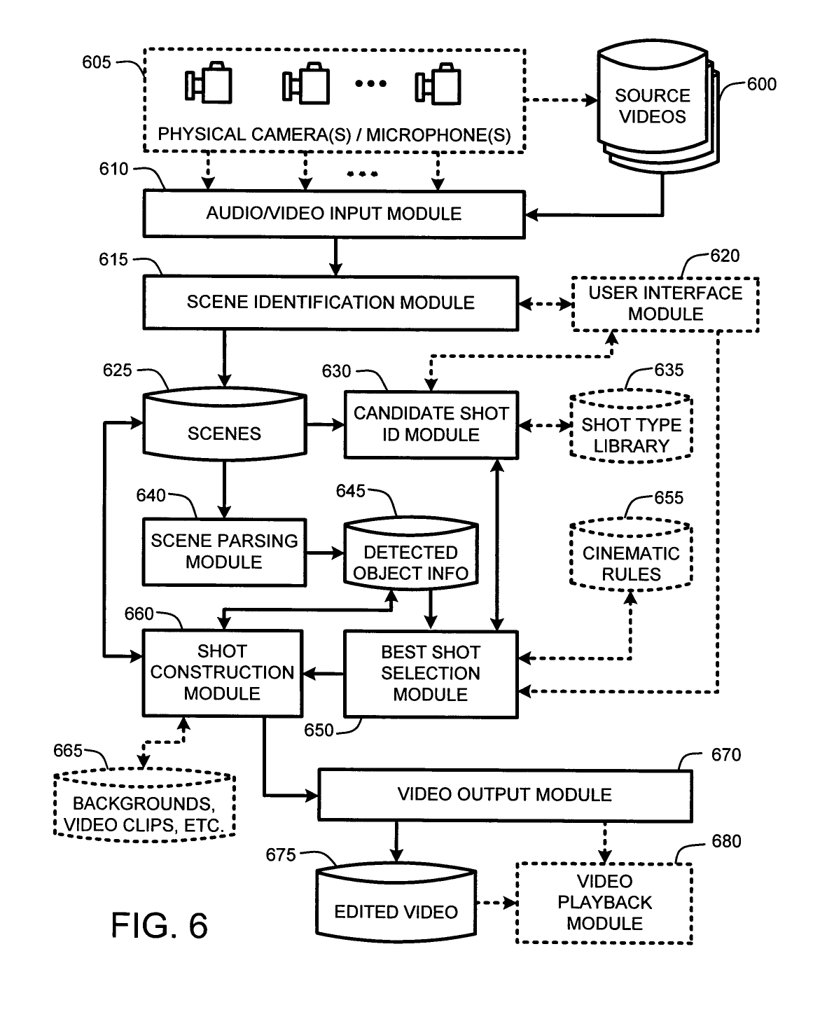

The processes summarized above are illustrated by the general system diagram of FIG. 6. In particular, the system diagram of FIG. 6 illustrates the interrelationships between program modules for implementing the AVE, as described herein. It should be noted that any boxes and interconnections between boxes that are represented by broken or dashed lines in FIG. 6 represent alternate embodiments of the AVE described herein, and that any or all of these alternate embodiments, as described below, may be used in combination with other alternate embodiments that are described throughout this document.

Note that the following discussion assumes the use of prerecorded video streams, with processing of all streams being handled in a sequential fashion without consideration of playback timing issues. However, as described herein, the AVE is fully capable of real-time operation, such that as soon as a scene change occurs in a live source video, the best shot for that scene is selected and constructed in real-time for real-time broadcast. However, for purposes of explanation, the following discussion will generally not describe real-time processing with respect to FIG. 6.

In general, as illustrated by FIG. 6, the AVE begins operation by receiving one or more source video streams, either previously recorded 600, or captured by video cameras 605 (with microphones, if desired) via an audio/video input module 610.

A scene identification module 615 then segments the source video streams into a plurality of separate scenes 625. In one embodiment, scene identification is accomplished using conventional scene detection techniques, as described herein. In another embodiment, manual identification of one or more scenes is accomplished through interaction with a user interface module 620 that allows user input of scene start and end points for each of the source video streams. Note that each of these embodiments can be used in combination, with some scenes 625 being automatically identified by the scene identification module 615, and other scenes 625 being manually specified via the user interface module 620. Note that scenes 635 are either extracted from the source videos and stored 625, or pointers to the start and end points of the scenes are stored 625.

Once the scenes 625 have been identified, either manually 620, or automatically via the scene selection module 615, a candidate shot identification module 630 is used to identify a set of possible candidate shots for each scene. Note that a preexisting library of shot types 635 is used in one embodiment to specify different types of possible shots for each scene 625. As described in further detail below, the candidate shots represent a ranked list of possible shots, with the highest priority shot being ranked first on the list of possible candidate shots.

Once the possible candidate shots for each scene have been identified, a scene parsing module 640 examines the content of each scene 625, using one or more detectors (e.g., conventional face or object detectors and/or trackers), for generally characterizing the content of each scene, and the relative positions of objects or faces located or tracked within each scene. The information extracted from each scene via this parsing is then stored to a file or database 645 of detected object information.

A best shot selection module 650 then selects a “best shot” from the list of candidate shots identified by the candidate shot identification module 630. Note that in various embodiments, this selection may be constrained by either or both the detected object information 645 derived from parsing of the scenes via the scene parsing module 640 or by one or more predefined cinematic rules 655. In general, an evaluation of the detected object information serves to provide an indication of whether a particular candidate shot is possible, or that success of achieving that shot has a sufficiently high probability. Tracking or detection reliability data returned by the various detectors of the scene parsing module 640 is used to make this determination.

Further, with respect to the cinematic rules 655, these rules serve to shift or weight the relative priority of the various candidate shots returned by the candidate shot identification module 630. For example, if a particular cinematic rule 655 specifies that no shot will repeat twice in a row, then if a shot in the candidate list matches the previously identified “best shot” for the previous scene, then that shot will be eliminated from consideration for the current scene. Further, it should be noted that in one embodiment, the best shot for a particular scene 625 can be selected via the user interface module 620.

Once the best shot has been selected by the best shot selection module 650, that shot is constructed by a shot construction module 660 using information extracted for the corresponding scenes 625. In addition, in constructing such shots, prerecorded backgrounds, video clips, titles, labels, text, etc. (665), may also be included in the resulting shot, depending upon what information is required to complete the shot.

Once the shot has been constructed for the current scene it is provided to a conventional video output module 670 which provides a conventional video/audio signal for either storage 675 as part of the output video stream, or for playback via a video playback module 680. Note that the playback can be provided in real-time, such as with AVE processing of real-time video streams from applications such as live video teleconferencing. Playback of the video/audio signal provided by the video playback module 680 uses conventional video playback techniques and devices (video display monitor, speakers, etc.)

3.0 Operation Overview:

The above-described program modules are employed for implementing the AVE. As summarized above, this AVE provides a system and method for automatically producing an edited output video stream from one or more raw or previously edited input video streams. The following sections provide a detailed discussion of the operation of the AVE, and of exemplary methods for implementing the program modules described in Section 2 in view of the operational flow diagram of FIG. 6 which is presented following a detailed description of the operational elements of the AVE.

3.1 Operational Elements of the Automated Video Editor:

As summarized above, and as described in specific detail below, the AVE generally provides automatic video editing by first defining a list of scenes available in each source video (as described in Section 3.1.3). Next, for each scene, the AVE identifies a rank-ordered list of candidate shots that would be appropriate for a particular scene (as described in Section 3.1.4). Once the list of candidate shots has been identified, the AVE then analyzes the source video using a current “parsing domain” (e.g., a of detectors, the reliability of the detectors, and any additional information provided by those detectors, as described in further detail in Section 3.1.2), for isolating unique objects (faces, moving/stationary objects, etc.) in each scene. Based on this analysis of the source videos, in combination with a set of cinematic rules, as described in further detail in Section 3.1.6, one or more “best shots” are then selected for each scene from the list of candidate shots. Finally, the edited video is constructed by compiling the best shots to create the output video stream. Note that in the case where insets are used, compiling the best shots to create the output video includes the use of the corresponding detectors for bounding the objects to be mapped (see the discussion of video mapping in Section 3.1.1) to construct the shots for each scene. These steps are then repeated for each scene until the entire output video stream has been constructed to automatically produce the edited video stream.

In providing these unique automatic video editing capabilities, the AVE makes use of several readily available existing technologies, and combines them with other operational elements, as described herein. For example, some of the existing technologies used by the AVE include video mapping and object detection. The following paragraphs detail specific operational embodiments of the AVE described herein, including the use of conventional technologies such as video mapping and object detection/identification. In particular, the following paragraphs describe video mapping, object detection, scene detection, identification of candidate shots; source video parsing; selection of the best shot for each scene; and finally, shot construction and output of the edited video stream.

3.1.1 Video Mapping:

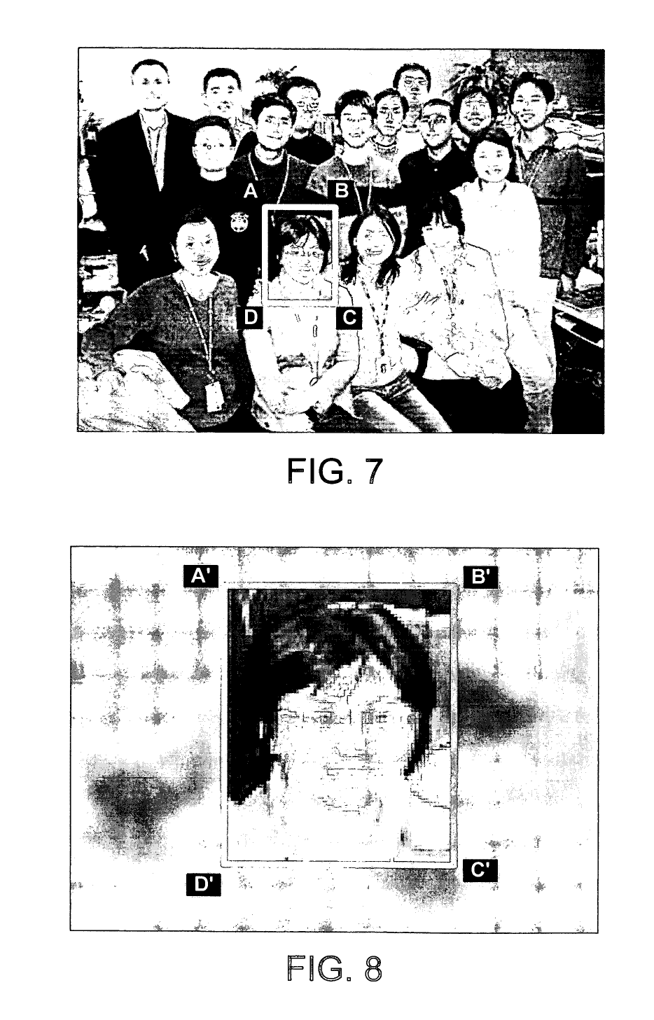

In general, video mapping refers to a technique in which a sub-area of one video stream is mapped to a different sub-area in another video stream. The sub-areas are usually described in terms of a source quadrangle and a destination quadrangle. For example, as illustrated by FIG. 7, the quadrangle represented by points {a, b, c, d} in video A is mapped onto the quadrangle {a′, b′, c′, d′} in video B, as illustrated in FIG. 8. Conventionally, such mapping is done using either software methods, or using the geometry processing unit (GPU) of a 3D graphics card. In this example, video A is treated as a texture in the 3D card's memory, and the quadrangle {a′, b′, c′, d′} is assigned texture coordinates corresponding to points {a, b, c, d}. Such techniques are well known to those skilled in the art. It should also be noted that such techniques allow several different source videos to be mapped to a single destination video. Similarly, such techniques allow several different quads in one or more source videos to be mapped simultaneously to several different corresponding quads in the destination video.

3.1.2 Object Detection, Identification, and Tracking:

In general, object detection techniques are well known to those skilled in the art. Object detection refers to a broad set of image understanding techniques which, when given a source image (such as a picture or video) can detect the presence and location of specific objects in the image, and in some cases, can differentiate between similar objects, identify specific objects (or people), and in some cases, track those objects across a sequence of image frames. In general, the following discussion will refer to a number of different object detection techniques as simply “detectors” unless specific object detection techniques or methods are discussed. However, it should be understood that in light of the discussion provided herein, any conventional object detection, identification, or tracking technique for analyzing a sequence of images (such as a video recording) is applicable for use with the AVE.

The types of objects detected using conventional detection methods are usually highly constrained. For example, typical detectors include human face detectors, which process images for identifying and locating one or more faces in each image frame. Such face detectors are often used in combination with conventional face recognition techniques for detecting the presence of a specific person in an image, or for tracking a specific face across a sequence of images.

Other object detectors simply operate to detect moving objects in an image sequence, without necessarily attempting to specifically identify what such objects represent. Detection of moving objects from frame to frame is often accomplished using image differencing techniques. However, there are a number of well known techniques for detecting moving objects in an image sequence. Consequently, such techniques will not be described in detail herein.

Still other object detectors analyze an image or image sequence to locate and identify particular objects, such as people, cars, trees, etc. As with face tracking, if these objects are moving from frame to frame in an image sequence, a number of conventional object identification techniques allow the identified objects to be tracked from frame to frame, even in the event of temporary partial or complete occlusion of a tracked object. Again, such techniques are well known to those skilled in the art, and will not be described in detail herein.

In general, detectors, such as those described above, work by taking an image source as input and returning a set of zero or more regions of the source image that bound any detected objects. While complex splines can be used to bound such objects, it is simpler to use bounding quadrangles that represent the bounding quadrangles of the detected objects, especially in the case where detected objects are to be mapped into an output video. However, while either method can be used, the use of bounding quadrangles will be described herein for purposes of explanation.

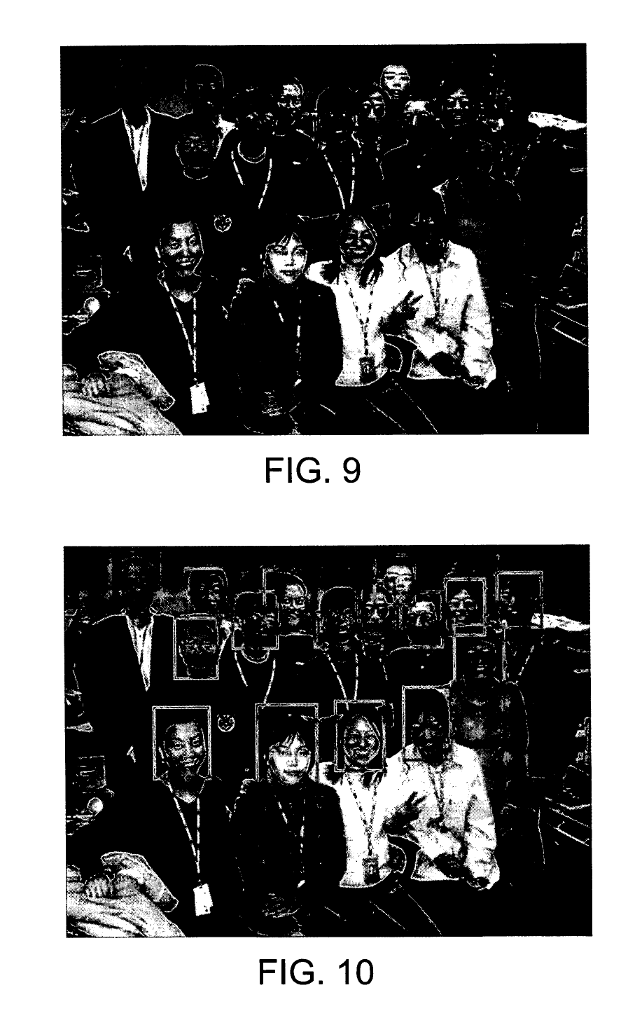

Depending on the type of detector being used, additional information such as the velocity of the detected object or a unique ID (for tracking an object across frames) may also be returned. This process is illustrated in FIGS. 9 and 10, which illustrates a face detector identifying faces in an image. Note that each of the 16 faces detected in FIG. 9 is shown bounded by bounding quadrangles in FIG. 10. Further, it should be noted that conventional face detection techniques allow the bounding quadrangles for detected faces to overlap, depending upon the size of the bounding quadrangle, and the separation between detected faces.

In a typical implementation each type of object that is to be detected in an image requires a different type of detector (such as “human face detector” or a “moving object detector”). However, multiple detectors are easily capable of operating together. Alternately, individual detectors having access to a large library of object models can also be used to identify unique objects. As noted above, any conventional detector is applicable for use with the AVE for generating automatically edited output video streams from one or more input video streams.

As is well known to those skilled in the art, detectors may be more or less reliable, with both a false-positive and false-negative error rate. For instance, a face detector may have a false-positive rate of 5% and a false-negative rate of 3%. This means that approximately 5% of the time, it will detect a face when there is none in the image, and 3% of the time it will not detect a face which the image contains.

Some detectors can also return more sophisticated additional information. For example, a human face detector may also be able to return information such as the position of the eyes, the facial expression (happy, sad, startled, etc.), the gaze direction, and so forth. A human hand detector may also be able to detect the pose of the hand in addition to the hand's location in the image. Often this additional information has a different (typically lower) accuracy rate. Thus, a face detector may be 95% accurate detecting a face but only 75% accurate detecting the facial expression.

In one embodiment, when such information is available it is used in combination with one or more of the cinematic rules. For example, one such use of facial expression information can be to cut to a detected face for a particular shot whenever that face shows a “startled” facial expression. Further, when processing such shots for non-real-time video editing, the cuts to the particular object (the startled face in this example), can precede the time that the face shows a startled expression so as to capture the entire reaction in that particular shot. Clearly, such cinematic rules can be expanded to encompass other expressions, or to operate with whatever particular additional information is being returned by the types of detectors being employed by the AVE in processing input video streams.

Finally, there are some detectors that are temporal in nature rather than spatial. A typical example would be speaker detection, which detects the number of speakers in the audio portion of the source video, and the times at which each one is speaking. As noted above, such techniques are well known to those skilled in the art.

Taken together, the set of detectors, the reliability of the detectors, and any additional information provided by those detectors define a “parsing domain” for each image. Parsing of the images, as described in further detail below, is performed to derive as much information from the input image streams as is needed for identifying the best shot or shots for each scene.

3.1.3 Scene Detection:

Shots in a video are inherently temporal in nature, with the video progressively transitioning from one scene to another. Each scene has a shot associated with it, and the shots require a definite start and end point. Therefore, the first step in the process is cutting or partitioning the source video(s) into separate scenes.

In some structured scenarios, scenes can be defined from the structure of the video itself. For example, in an implementation of the AVE in camera-based video game, a computerized host might assign the player a task. Then, while the player completes the assigned task, the AVE can automatically cut to a shot of the player, which is mapped into a scene in the game from an input video stream (or single image) of the player or the players face. The mapping in this simple example can be to an entire video frame or frames representing the edited output scene, or to some sub-region of the output scene, such as by mapping the player onto some background or object (either 2D or 3D, and either stationary or moving in the output video stream). Note that such mapping is described above in Section 3.1.1.

As is well known to those skilled in the art, in a non-structured scenario (unlike the game scenario described above, where the scenes are predefined in programming the game), there are many ways of detecting scenes in a video stream. For example, one common method is to use conventional speaker identification techniques to identify a person that is currently talking, then, as soon as another person begins talking, that transition corresponds to a “scene change.” Such detection can be performed, for example, using a single microphone in combination with conventional audio analysis techniques, such as pitch analysis or more sophisticated speech recognition techniques. Note that speaker detection is frequently performed in real-time using microphone arrays for detecting the direction of received speech, and then using that direction to point a camera towards that speech source. Other conventional scene detection techniques typically look for changes in the video content, with any change from frame to frame that exceeds a certain threshold being identified as representing a scene transition. Note that such techniques are well known to those skilled in the art, and will not be described in detail herein.

3.1.4 Generation of Candidate Shot Lists:

In general, shots represent a number of sequential image frames, or some sub-section of a set of sequential image frames, comprising an uninterrupted segment of a video sequence. Basically, the shot represents some subset of a scene, up to, and including, the entire scene, or some collection of portions of several source videos that are to be arranged in some predetermined fashion. From any given scene, there are typically a number of possible shots.

For example, a shot might consist of a digital pan of all or part of a scene, where a fixed size rectangle tracks across the input video stream (with the contents of the rectangle either being scaled to the desired video output size, and/or mapped to an inset in the output video).

Another shot might consist of a digital zoom, where a rectangle that changes size over time tracks across a scene of the input video stream, or remains in one location while changing size (with the contents of the rectangle again being scaled to the desired video output size, and/or mapped to an inset in the output video).

With respect to shots involving insets, this simply represents an instance where one image (such as a particular detected face or object) is shown inset into another image or background. Note that the use of insets is well known to those skilled in the art, and will not be described in detail herein. Still other possible shots involve 3D effects where an image (such as a particular detected face or object) is shown mapped onto the surface of a 3D object. Such 3D mapping techniques are well known to those skilled in the art, and will not be described in detail herein.

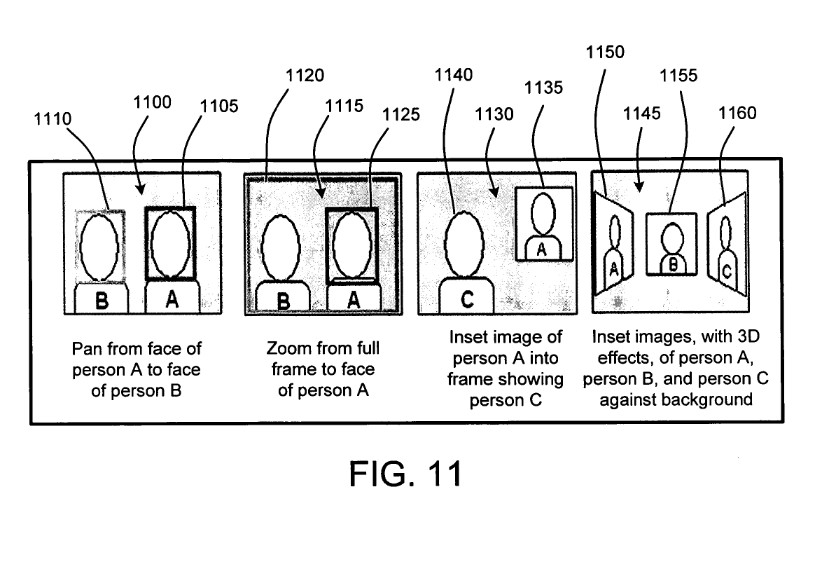

FIG. 11 illustrates a few the many possible examples of shots that can be derived from one or more input source videos. For example, from left to right, the left most candidate shot 1100 represents a pan created from a single source video, where the shot will be a digital pan (with digital image scaling being used, if desired, to fill all or part of each frame of the output video stream) from a bounding quadrangle 1105 covering the face of person A to the bounding quadrangle 1110 covering the face of person B. As described above, these bounding quadrangles, 1105 and 1110, are determined using conventional detectors, which in this case, are face detectors.

Next, candidate shot 1115 represents a zoom-in type shot created from a single source video, where the shot will be a digital zoom in from a bounding quadrangle 1120 covering both person A and person B to a bounding quadrangle 1125 covering only the face of person B.

The next example of a candidate shot 1130 illustrates the use of one or more source or input video streams to generate an output video having an inset 1135 of person A in a video frame showing person C 1140. As with the previous examples, a bounding quadrangle can be used to isolate the image of person A 1135 using a conventional detector for detecting faces (or larger portions of a person) so that the detected person can be extracted from the corresponding source video stream and mapped to the frame containing person C, as illustrated in candidate shot 1130.

Finally, the in the last example of a candidate shot 1145, inset images of person A 1150, person B 1155, and person C 1160 are used to generate an output video by mapping insets of each person onto a common background. As with the previous example, each person (1150, 1155, and 1160) is isolated from one or more separate source video streams via conventional detectors and bounding quadrangles, as described above. In addition, note that a 3D effect is simulated in this example by using conventional 3D mapping effects to the warp the insets of person A 1150 and person C 1160 to create an effect simulating each person being in a group generally facing each other. Note that this type of candidate shot is particularly useful in constructing a shot of multiple people holding a simultaneous conversation, such as with a real-time multi-point video conference.

It should be noted that the candidate list of possible shots for each scene generally depends on what type of detectors (face recognition, object recognition, object tracking, etc.) are available. However, in the case of user interaction, particular shots can also be manually specified by the user in addition to any shots that may be automatically added to the candidate list. This manual user selection can also include manual user designation or placement of bounding quadrangles for identifying particular objects or regions of interest in one or more source video streams. Further, it should also be noted that the examples of candidate shots described above are provided only for purposes of explanation, and are not intended to limit the scope of types of candidate shots available for use by the AVE. Clearly, as should be well understood by those skilled in the art, many other types of candidate shots are possible in view of the teachings provided herein. The basic idea is to predefine a number of possible shots or shot types that are then available to the AVE for use in constructing the edited output video stream.

3.1.5 Source Video Parsing:

As noted above, the purpose of parsing the source video is to analyze each of the source or input video streams using information derived from the various detectors to see what information can be gleaned from the current scene. For example, since video editing often centers on the human face, a conventional face detector is particular useful for parsing video streams. A face detector will typically work by outputting a record for each video frame which contains where each face is in the frame, whether any of the faces are new (just entered this frame), and whether any faces in the precious frame are no longer there. Note that this information can also be used to track particular faces (using moving bounding quadrangles, for example) across a sequence of image frames.

The exact type of parsing depends upon the application, and can be affected by many factors, such as which shots the AVE is interested in, how accurate the detectors are, and even how fast the various detectors can work. For example, if the AVE is working with live video (such as in a video teleconferencing application, for example), the AVE must be able to complete all parsing in less than 1/30th of a second (or whatever the current video frame rate might be).

It must be noted that the shot selection described above is independent from the video parsing. For example, assuming that the parsing identifies three unique objects, A, B and C, (and their corresponding bounding quadrangles) in one or more unique video streams, one candidate shot might be to “cut from object A to object B to object C.” Given the object information available from the aforementioned video parsing, construction of the aforementioned shot can then proceed without caring whether objects A, B, and C are in different locations in a single video stream or each have their own video stream. The objects are simply extracted from the locations identified via the video parsing and placed, or mapped, to the output video stream. An example of a corresponding cinematic rule can be: “for n detected objects, sequentially cut from object 1 through object n, with each object being displayed for period t in the output video stream.

3.1.6 Best Shot Selection:

As noted above, one ore more candidate shots are identified for each identified scene. Consequently, the concept of “best shot selection” refers to the method that goes from the list of one or more candidate shots to the actual selected shot by selecting a highest priority shot from the list. There are several techniques for selecting the best shot, as described below.

One method for identifying the best shot involves examining the parsing results to determine the feasibility of a particular shot. For example, if a person's face can not be detected in the current scene, then the parsing results will indicate that the face can not be detected. If a particular shot is designed to inset the face of that person while he or she is speaking, an examination of the corresponding parsing results will indicate that the particular shot is either not feasible, or will not execute well. Such shots would be eliminated from the candidate list for the current scene, or lowered in priority. Similarly, if the face detector returns a probable location of a face, but indicates a low confidence level in the accuracy of the corresponding face detection, then the shot can again be eliminated from the candidate list, or be assigned a reduced priority. In such cases, a cinematic rule might be to assign a higher priority to a shot corresponding to a wider field of view when the speaker's face can not be accurately located in the source video stream.

Another use of the parsing results can be to force particular shots. This use of the parsing results is useful for applications such as, for example, a game that uses live video. In this case, the AVE-based game would automatically insert a “PAUSE” screen, or the like, when the face detector sees that the player has left the area in which the game is being played, or in which the detector observes a player releasing or moving away from a game controller (keyboard, mouse, joystick, etc.).

Another method for selecting the best shot involves the use of the aforementioned cinematic rules. For example, given a list of predefined shot types (pans, zooms, insets, cuts, etc., cinematic style rules can be defined which make shots either more or less likely (higher or lower priority). For instance, a zoom in immediately followed by a zoom out is typically considered bad video editing style. Consequently, one simple cinematic rule is to avoid a zoom out if a zoom in shot was recently constructed for the output video stream. Other examples of cinematic rules include avoiding too many of the same shot in a row, avoiding a shot that would be too extreme with the current video data (such as a pan that would be too fast or a zoom that would be too extreme (e.g., too close to the target object). Note that these cinematic rules are just a few examples of rules that can be defined or selected for use by the AVE. In general, any desired type of cinematic rule desired can be defined. The AVE then processes those rules in determining the best shot for each scene.

Yet another method for selecting the best shot is as a function of an application within which the AVE has been implemented for constructing an output video stream. For example, a particular application might demand a particular shot, such as a game that wants to cross-cut between video insets of two or more players, either at some interval, or following some predetermined or scripted event, regardless of what is in their respective videos (e.g., regardless of what the video parsing might indicate). Similarly, a particular application may be designed with a “template” which weights the priority of particular types of shots relative to other types of shots. For example, a “wedding video template” can be designed to preferentially weight slow pans and zooms over other possible shot types.

Finally, as noted above, in one embodiment, user selection of particular shots is also allowed, with the user specifying either particular shots, and/or particular objects or people to be included in such shots. Further, in a related embodiment, a menu or list of all possible shots is provided to the user via a user interface menu so that the user can simply select from the list. In one embodiment, this user selectable list is implemented as a set of thumbnail images (or video clips) illustrating each of the possible shots.

In a related embodiment, the AVE is designed to prompt the user for selecting particular objects. For example, given a “birthday video template,” the AVE will allow the user to select a particular face from among the faces identified by the face detector as representing the person whose birthday it is. Individual faces can be highlighted or otherwise marked for user selection (via bounding boxes, spotlight type effects, etc.) In fact, in one embodiment, the AVE can highlight particular faces and prompt the user with a question (either via text or a corresponding audio output) such as “Is THIS the person whose birthday it is?” The AVE will then use the user selection information in deciding which shot is the best shot (or which face to include in the best shot) when constructing the shot for the edited output video stream.

It should also be noted that any or all of the aforementioned methods, including examining the parsing results, the use of cinematic rules, specific application shot requirements, and manual user shot selection, can be combined in creating any or all scene of the edited output video stream.

3.1.7 Shot Construction and Video Output:

Once the best shot is selected, the AVE constructs the shot from the source video stream or streams. As noted above, any particular shot may involve combining several different streams of media. These media streams may include media content, including, for example, multiple video streams, 2D or 3D animation, still images, and image backgrounds or mattes. Because the shot has already been defined in the candidate list of shots, it is only necessary to collect the information corresponding to the selected shot from the one or more source video streams and then to combine that information in accordance with the parameters specified for that shot.

It should also be noted that any desired audio source or sources can be incorporated into the edited output video stream. The inclusion of audio tracks for simultaneous playback with a video stream is well known to those skilled in the art, and will not be described herein.

4.0 Operational Examples of the Automated Video Editor:

In addition to the examples of automated video teleconferencing and video editing applications enabled by use of the AVE described herein, there are numerous additional applications that are also enabled by use of the AVE. The following paragraphs describe various embodiments of implementations of the AVE in either a fully automatic editing mode or a semi-automatic user assisted mode.

4.1 AVE-Enabled Computer Video Game:

In one embodiment which provides an example of fully automatic editing, the real-time video editing capabilities of the AVE are used to enable a computer video game in which live video feed of the players provides a key role. For example, the video game in question could be constructed in the format of a conventional television game show, such as, for example, Jeopardy™, The Price is Right™, Wheel of Fortune™, etc. The basic format of these games is that there is a host who moderates activities, along with one or more players who are competing to get the best score or for other prizes. The structure of these shows is extremely standardized, and lends itself quite well to breakdown into predefined scenes.

For example, typical predefined scenes in such a computer video game might include the following scenes:
1. “New player starts/joins game”
2. “Player responds to put-down/comment from host”
3. “Player 2 is about to beat player 1's high score”
4. “Player 3 blows it by answering an easy question incorrectly”.

Each of these predefined scenes will then have an associated list of one or more possible shots (e.g., the candidate shot list), each of which may or may not be feasible at any given time, depending upon the results of parsing the source video streams, as described above. Clearly, other scenes, as appropriate to any particular game, can be defined, including, for example, an “audience reaction” scene in the case where there are additional video feeds of people that are merely watching the game rather than actively participating in the game. Such a scene may include possible candidate shots such as, for example, insets or pans of some or all of the faces of people in the “audience.” Such scenes can also include prerecorded shots of generic audience reactions that are appropriate to whatever event is occurring in the game.

Given this generic computer video game setup, one or more players can be seated in front of each of one or more computers equipped with cameras. Note that as with video conferencing applications, there does not need to be a 1:1 correspondence between players and computers—some players can share a computer, while others could have their own. Note that this feature is easily enabled by using face detectors to identify the separate regions of each source video stream containing the faces of each separate player.

In such a game, the video of the “host” can either be live, or can be pre-generated, and either stored on some computer readable medium, such as, for example, a CD or DVD containing the computer video game, or can be downloaded (or even streamed in real time) from some network server.

Given this setup, e.g., predefined scenes and a list of candidate shots for each scene, source video streams of each player, and a video of the “host,” the AVE can then use the techniques described above to automatically produce a cinematically edited game experience, cutting back and forth between the players and host as appropriate, showing reaction shots, providing feedback, etc. For instance, during a scene in which player 2 is about to beat player 1's score, the priority for a shot having player 2 full-frame, with player 1 shown in a small inset in one corner of the frame to show his/her reaction, can be increased to ensure that the shot is selected as the best shot, and thus processed to generate the output video stream. Note that in this particular shot, the host can be placed off-screen, but any narration from the host can continue as a part of the audio stream associated with the edited output video stream.

4.2 AVE-Enabled Video Conferencing/Chat:

In another embodiment which provides an example of fully automatic editing, the real-time video editing capabilities of the AVE are combined with a video conferencing application to generate an edited output video stream that uses live video feed of the various people involved in the video conversation.

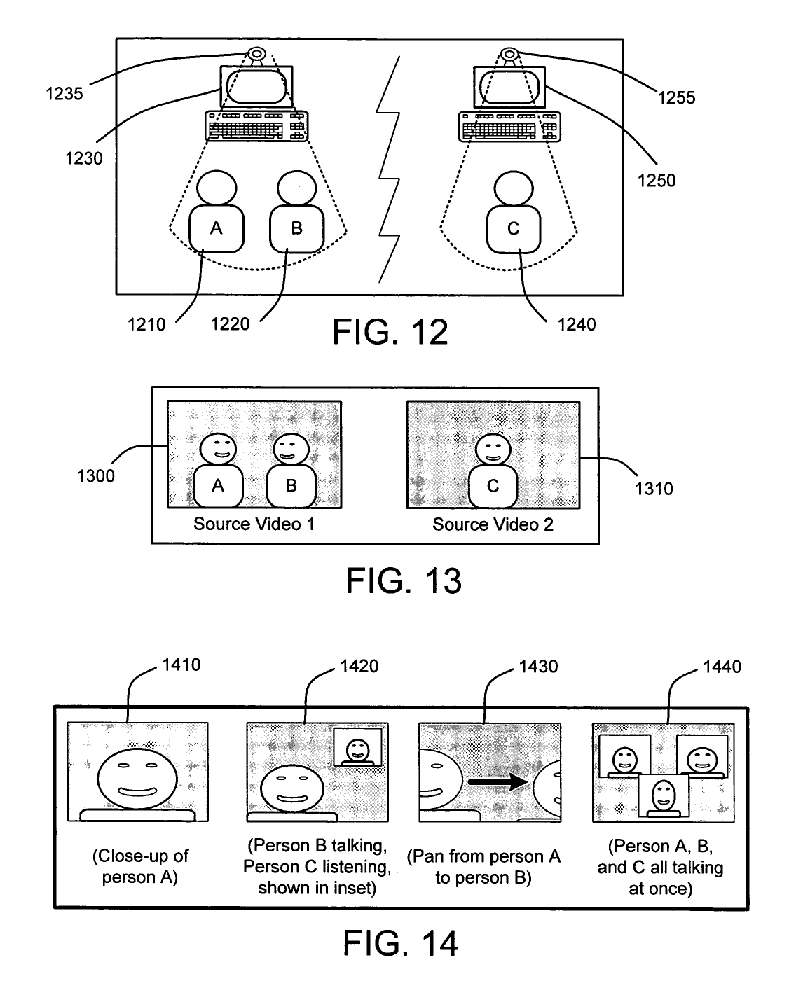

For example, as illustrated in FIG. 12, consider the case of filming a conversation between two people, (person A and person B, 1210 and 1220, respectively) sitting in front of a first computer 1230 and third person (C, 1240) sitting in front of a second computer 1250 in some remote location. Each computer, 1230 and 1250 includes a video camera 1235 and 1255, respectively. Consequently, there are two source video streams 1300 and 1310, as illustrated in FIG. 13, with the first source video showing person A and person B, and the second source video showing person C.

Now consider the problem of adding a fourth person (D), at yet another remote location, as an observer to the conversation (without providing a third source video stream for that fourth person). In a conventional system, the only option for person D is to choose between viewing video stream 1 and video stream 2, to view one stream inset into the other in some predefined position (such as picture-in-picture television), or to view both streams simultaneously in some sort of split-screen arrangement.

However, using the AVE to edit the output video stream, a number of capabilities are enabled. For example, as described above, speaker detection can be used to break each source video into separate scenes, based on who is currently talking. Further, a face detector can also be used to generate a bounding quadrangle for selecting only the portion of the source video feed for the person that is actually speaking (note that this feature is very useful with respect to source video 1 in FIG. 13, which includes two separate people) for use in constructing the “best shot” for each scene. As noted above, this type of speaker detection is easily accomplished in real-time using conventional techniques so that speaker changes, and thus scene changes, are identified as soon as they occur.

Given the video conferencing setup described above with respect to FIG. 12 and FIG. 13, and the scene changes detected as a function of who is speaking, a predefined list of possible shots is then provided as the candidate shot list. This list can be constructed in order of priority, such that the highest priority shot which can be accomplished, based on the parsing of the input video streams, as described above, is selected as the best shot for each scene. Note also, that this selection is also modified as a function of whatever cinematic rules have been specified, such as, for example, a rule that limits or prevents particular shots from immediately repeating. A few examples of possible candidate shots for this list include shots such as:
1. A close-up of the person speaking;
2. A reaction-shot of one of the listeners;
3. A pan from one speaker to the next;
4. A full shot of all simultaneous speakers; and
5. An inset shot, showing the speaker full-screen and the listeners in small insets rectangles overlaid on top of the full-screen speaker.

Given the conferencing setup described above and the exemplary candidate list, the AVE would act to construct an edited output video from the two source videos by performing the following steps:
1. The current scene is analyzed using face detection to determine where the faces are in the signals;
2. A shot is selected from the candidate list, being sure not to select too many repetitive shots (this is a cinematic rule) or shots that are not possible (for example, it isn't possible to have a listener reaction shot if the listener has momentarily left the camera's view, as determined via parsing of the source video stream.)
3. Video mapping is then used to construct the selected shot from the source videos;
4. The constructed shot is then fed in real-time to the output video stream for the observer (and for each of the other participants in the video conference, if desired.)

FIG. 14 illustrates a few the many possible examples of shots that can be derived from the two source videos illustrated in FIG. 13. For example, from left to right, the left most candidate shot 1410 represents a close-up or zoom of person A while that person is talking. As described above, this close-up can be achieved by tracking person A as he talks, and using the information within the bounding quadrangle covering the face of person A in constructing the output video stream for the corresponding scene. As described above, this bounding quadrangle can be determined using a conventional face detector.

The next example of a candidate shot 1420 illustrates the use of both of the source videos illustrated in FIG. 13. In particular, this candidate shot 1420 includes a close-up or zoom of person B as that person is talking, with an inset of person A shown in the upper right corner of that candidate shot. As with the previous examples, a bounding quadrangle can be used to isolate the images of both person A and person B in constructing this shot, with the choice of which is in the foreground, and which is in the inset being determined as a function of who is currently talking.

In yet another example of a candidate shot 1430 that can be generated from the exemplary video conferencing setup described above, a digital zoom of the first source video 1300 of FIG. 13 is used I combination with a digital pan of that source video to show pan from person A to person B.

Finally, the in the last example of a candidate shot 1440, inset images of person A 1210, person B 1220, and person C 1240 are used to generate an output video by mapping insets of each person onto a common background while all three people are talking at the same time. As with the previous example, each person (1210, 1220, and 1240) is isolated from their respective source video streams via conventional detectors and bounding quadrangles, as described above. In addition, note that an optional 2D mapping effect is used such that one of the insets partially overlays both of the other two insets. This type of candidate shot is particularly useful in constructing a shot of multiple people holding a simultaneous conversation, such as with a real-time multi-point video conference.

The object detection techniques generally discussed above allows the AVE to automatically accomplish the effects of each of the candidate shots described above with a high degree of fidelity. For example, a shot in the library of possible candidate shots can be described simply as “Pan from person A to B”, and then, with the use of face tracking or face detection techniques, the AVE can compute the appropriate pan even if the faces are moving.

It should also be noted that a different edited output video stream can be provided to each of the participants and observers of the video conference, if desired. In particular, rather than generate a single output video stream, two or more output video streams, each constructed using a different set of possible shots, or cinematic rules, (e.g., don't show a reaction shot of a listener to his or her self) is constructed, as described herein and, with one of the streams being provided to any one or more of the participants or listeners.

The foregoing example leverages the fact that the AVE knows the basic structure of the video in advance—in this case, that the video is a conversation amongst several people. This knowledge of the structure is essential to select appropriate shots. In many domains, such as video conferencing and games, this structure is known to the AVE. Consequently, the AVE can edit the output video stream completely without human intervention. However, if the structure is not known, or is only partially known, then some user assistance in selecting particular shots or scenes is required, as described above and as discussed in Section 2 with respect to another example of an AVE enabled application.

4.3 User-Assisted Semi-Automatic Editing for a Non-Structured Video Recording:

In another embodiment which provides an example of semi-automatic editing, the video editing capabilities of the AVE are used in combination with some user input to generate an edited output video stream from an pre-recorded input video stream.

For example, consider the case of the home video of a birthday party, as described above with respect to FIGS. 2 and 3. As described above, this video is recorded with a single fixed video camera, and generally lacks drama and excitement, even though it captures the entire event. However, the AVE described herein can be used to easily generate an edited version of the birthday party which more closely approximates the “professional version” of that birthday party, as described above with respect to FIG. 5.

In particular, given the setup described above, the AVE would act to construct an edited output video from the source video of the birthday party by performing the following steps (with some user assistance, as described below):
1. The video of the birthday party would first be broken up into scenes. Note that identifying the scenes in the video can be accomplished manually by the user, who might for example divide it into several scenes, including, for example, “singing birthday song”, “blowing out candles”, one scene for each gift, and a conclusion. These particular scene types could also be suggested by the AVE itself as part of a “birthday template” which allows the user to specify start and end points for those scenes. Alternately, standard scene detection techniques, as described above, can be used to break the video into a number or unique scenes.
2. For each scene, a list of candidate shots would be generated. These could be selected from a list of all possible shots, or could be informed by the template. For instance, the birthday template may recommend “extreme zoom in to birthday person” as the top pick for the “blowing out candles” scene. In this case, the user would identify the person who was celebrating their birthday, either manually, or via selection of a bounding quadrangle encompassing the face of that person as a function of the face detector.
3. Each scene would be parsed or analyzed for face detection. In one embodiment, the different faces detected can be added to a user interface as a palette of faces, to make it easy to construct shots that, say, pan from person A to person B by simply allowing the user to select the two faces, and then select a pan-type shot.
4. Using the data from step (3), the list of candidate shots in (2) can then be further refined, if desired, to eliminate shots that are not relevant, or that the user otherwise wants removed from the list for a particular scene. The user would then selects the particular shot he wants for the current scene. In the event that the user is violating one of the predefined cinematic rules, a warning or alert is provided in one embodiment to alert the user to the fact that a particular rule is being violated (such as too many extreme zoom-ins, or a zoom in immediately followed by a zoom out.)
5. Finally, once the desired shot is selected for each scene, the AVE constructs the shot, as described above. The shot is then either automatically added to the edited output video stream, or provided for preview to the user for a user determination as to whether that shot is acceptable for the current scene, or whether the user would like to generate an alternate shot for the current scene. It should be noted that in the case of this type of user input, the user will the option of generating multiple shots for any particular scene if he so desires.

The steps described above are easily contrasted with a conventional video editing system, wherein the user would have to work directly with low-level video mapping tools to accomplish effects similar to those described above. For example, in a conventional editing system, if the user wanted to construct a pan from person A to person B, the user would have to figure out the location of the faces in the shot, then manually track a clipping rectangle from the start location to the destination, distorting it as needed to compensate for different face sizes. By hand, it is extremely difficult to make such transitions look aesthetically pleasing without doing a lot of detailed fine-tuning. However, as described above, the AVE makes such editing automatic.

The foregoing description of the AVE has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the AVE. It is intended that the scope of the invention be limited not by this detailed description, but rather by the claims appended hereto.

What is claimed is:

1. An automated video editing system for real-time multi-point video conferencing, comprising steps for:
receiving two or more real-time input video streams;
evaluating each input video stream to identify locations of any people in each video stream, and determining whether any of the people are currently speaking;
partitioning each input video stream into one or more possible candidate shots corresponding to the identified locations of the people located in each video stream, and relative to whether any of those people are currently speaking;
selecting at least one best shot from the list of possible candidate shots; and
constructing at least one unique output video stream for real-time playback from the selected best shots.

2. The automated video editing system of claim 1 wherein real-time playback of the constructed video streams is accomplished in real-time within a maximum delay on the order of about one video frame.

3. The automated video editing system of claim 1 wherein types of possible candidate shots include any one or more of:
a close-up of a person currently speaking;
a reaction-shot of one or more people not currently speaking;
a pan shot from one person currently speaking to another person currently speaking;
a full shot of all people currently speaking simultaneously; and
an inset shot, showing one or more persons in scaled insets overlaid on top of a larger shot of another located person.

4. The automated video editing system of claim 1 wherein a list of possible candidate shots is predefined as part of a user selectable template.

5. The automated video editing system of claim 1 wherein the steps for evaluating each input video stream to identify locations of any people in each video stream further comprises steps for using face detection techniques to bound locations of the people identified in each input video stream.

6. The automated video system of claim 1 wherein the steps for constructing the at least one output video stream comprises steps for mapping one or more of the selected best shots to one or more of the output video streams.

7. The automated video system of claim 6 wherein the steps for mapping the selected best shots to one or more of the output video streams further comprises steps for mapping the selected best shots as a function of one or more predefined cinematic rules, said cinematic rules defining any of allowed:
shot types;
shot arrangements;
shot positioning;
shot scaling;
shot transitions; and
shot combinations.

8. A computer-readable medium having computer-executable instructions for implementing the automated video editing system of claim 1.

9. A method for generating an edited output video stream for real-time viewing by one or more participants in a multi-point video conference, comprising using a computing device to:
receive one or more input video streams from one or more separate participant sites, each input video stream including one or more people;
locate each person in each input video stream by bounding unique regions in each video stream corresponding to one or more of the located people;
partitioning each input video stream into one or more possible candidate shots corresponding to the bounded regions in each video stream;
determining whether any of the located people are currently speaking;
selecting a set of at least one best shot from the list of possible candidate shots as a function of whether any of the located people are currently speaking; and
constructing at least one unique output video stream from the set of selected best shots for real-time playback and viewing by one or more of the participants in the multi-point video conference

10. The method of claim 9 further comprising providing real-time playback of one or more of the constructed output video streams to third party viewers not acting as participants in the multi-point video conference.

11. The method of claim 9 further comprising recording one or more of the constructed output video streams for non-real-time playback of the constructed output video streams.

12. The method of claim 9 wherein selection of the best shots further comprises evaluating a set of predefined cinematic rules for determining the best shots to be selected.

13. The method of claim 9 wherein identifying possible candidate shots is constrained by a user selectable shot template which defines a set of allowable candidate shots.

14. The method of claim 9 wherein constructing at least one unique output video stream from the set of selected best shots comprises mapping one or more of the selected best shots to one or more of the output video streams using any of shot translations, scales, warps, insets, overlays, and predefined backgrounds.

15. The method of claim 9 wherein constructing at least one unique output video stream from the set of selected best shots further comprises including one or more text labels in the one or more of the output video streams.

16. A computer-readable medium having computer executable instructions for automatically generating at least one output video stream for playback and viewing by participants in a real-time multi-point video conference, said computer executable instructions comprising:
examining one or more input video streams of participants in the multi-point video conference to detect and bound faces of people in the input video streams;
examining one or more input audio streams synched to each of the input video streams to determine which, if any, of the detected people are currently speaking;
identifying a set of possible candidate shots from each input video stream as a function of the bounded faces and the determination of whether any of the people are speaking;
selecting a set of one or more best shots from the set of possible candidate shots for each of at least one output video streams, said best shot selection being further constrained by a set of one or more cinematic rules;
constructing each of the output video streams from the corresponding selected best shots; and
providing a real-time playback of one or more of the output video streams to one or more of the participants in the real-time multi-point video conference.

17. The computer-readable medium of claim 16 wherein predefined types of possible candidate shots include any one or more of:
a close-up of a person currently speaking;
a reaction-shot of one or more people not currently speaking;
a pan shot from one person currently speaking to another person currently speaking;
a full shot of all people currently speaking simultaneously; and
an inset shot, showing one or more persons in scaled insets overlaid on top of a larger shot of another located person.

18. The computer-readable medium of claim 16 wherein constructing each of the output video streams includes segmenting portions of one or more of the frames of the corresponding selected best shots and applying one or more of: digital video cropping, overlays, insets, digital zooms, and predefined backgrounds, to construct the output video streams.

19. The computer-readable medium of claim 16 wherein the cinematic rules define shot criteria including one or more of: a desired frequency for particular shot types, avoidance of shot repetition, and desired shot sequence.

20. The computer-readable medium of claim 16 further comprising including one or more text labels in the one or more of the constructed output video streams.
